(19) United States
(12) Patent Application Publication
(10) Pub. No.: US 2024/0333073 A1
(43) Pub. Date: Oct. 3, 2024

(54) MOTOR AND METHOD OF MANUFACTURING THE SAME

(71) Applicant: HL MANDO CORPORATION, Gyeonggi-do (KR)

(72) Inventors: Baikkee SONG, Gyeonggi-do (KR); Kiwon KANG, Gyeonggi-do (KR)

(21) Appl. No.: 18/622,969

(22) Filed: Mar. 31, 2024

(30) Foreign Application Priority Data
Mar. 31, 2023 (KR) 10-2023-0042495
Mar. 13, 2024 (KR) 10-2024-0035260

(51) Int. Cl. H02K 5/15; H02K 5/10; H02K 5/16; H02K 15/14

(52) U.S. Cl. CPC H02K 5/15; H02K 5/10; H02K 5/16; H02K 15/14; H02K 2213/03

(57) ABSTRACT

A motor including a stator and a rotor disposed to be spaced apart from an inner circumferential surface of the stator may includes a housing in which the stator and the rotor are accommodated and an opening centered on a rotation axis and exposing at least a portion of the rotor is provided and a cover member covering the opening of the housing, wherein, in the housing, a curled portion is formed to be curvedly curled such that a wall thereof forming an edge portion of the opening faces the rotation axis, and the curled portion comes into contact with an edge portion of the cover member to seal the opening.

### CROSS-REFERENCE TO RELATED APPLICATION

This application claims the benefit of Korean Patent Application No. 10-2023-0042495, filed on Mar. 31, 2023 and Korean Patent Application No. 10-2024-0035260, filed on Mar. 13, 2024 in the Korean Intellectual Property Office, the disclosure of which is incorporated herein by reference.

### BACKGROUND

### 1. Field

Embodiments of the present disclosure relate to a motor and a method of manufacturing the same, and more specifically, to a motor, which is coupled to a pump piston, receives a load, and has an assembly structure which supports the load and seals an inner portion of the motor, and a method of manufacturing the same.

### 2. Description of the Related Art

Generally, brake systems for performing braking are necessarily mounted in vehicles, and recently, various types of electronic brake systems have been proposed for obtaining a stronger and more stable braking force. As an example, intelligent integrated dynamic brake (IDB) systems have been proposed. The IDB system is proposed to generate a stable and strong braking force by integrating a master booster and a vehicle electronic stability control (ESC) system.

In such an electronic brake system, a pedal displacement sensor outputs the movement of a pedal as an electrical signal to operate a motor, and the electronic brake system includes a hydraulic pressure supply device which converts a rotational force of the motor into a linear motion to generate braking hydraulic pressure, a modulator block in which a plurality of valves are installed to receive the hydraulic pressure and control a braking operation using a force generated by the hydraulic pressure supply device, and an electronic control unit which controls the motor and the valves.

More specifically, in the integrated electronic brake system, the hydraulic pressure supply device operates according to the movement of a brake pedal to generate a braking pressure desired by a driver and transmits the hydraulic pressure to a wheel cylinder installed on each wheel. In this case, the hydraulic pressure supply device includes a motor, a pinion gear rotated by the motor, and a rack gear which moves linearly while engaged with the pinion gear. That is, in the hydraulic pressure supply device, the pinion gear is installed on a surface facing the rack gear to be engaged with the rack gear so that the rack gear can move linearly.

However, since the hydraulic pressure supply device provided with the above-described components is driven in a rack and pinion manner to generate braking pressure, there are problems of increasing the size of a rack gear driving device and excessively increasing weight. Therefore, there is a problem of degrading the mountability thereof in a vehicle and a lay-out design.

In order to solve the above problems, a hydraulic pressure supply device of an electronic brake system, which operates with a simple structure using a ball screw method, was proposed. However, in such a ball screw type motor, during the pressurization of the hydraulic pressure supply device, a load due to action and reaction is transmitted to an inner ring of a bearing. The load transmitted to the inner ring is transmitted to an outer ring of the bearing, and a housing supports the load so that the hydraulic pressure supply device generates pressure.

When such a motor housing is formed through a press method, since a thickness of the housing is small, it is difficult to form a tab structure for sealing and assembling a cover. In addition, in a double-acting hydraulic pressure supply device, a load needs to be supported in two directions.

In addition, when a ball screw is assembled in a motor, it is necessary to, after the ball screw is assembled, close a cover to form a sealing structure to prevent foreign matter from being introduced into the motor from the outside.

### SUMMARY

Therefore, it is an aspect of the present disclosure to provide a motor, particularly a motor which is coupled to a pump piston, receives a load, and has an assembly structure which supports the load and seals an inner portion of the motor, and a method of manufacturing the same.

In accordance with one aspect of the present disclosure, a motor including a stator and a rotor disposed to be spaced apart from an inner circumferential surface of the stator includes a housing in which the stator and the rotor are accommodated and an opening centered on a rotation axis and exposing at least a portion of the rotor is provided and a cover member covering the opening of the housing, wherein, in the housing, a curled portion is formed to be curvedly curled such that a wall thereof forming an edge portion of the opening faces the rotation axis, and the curled portion comes into contact with an edge portion of the cover member to seal the opening.

The motor may further include a sealant portion sealing a gap between the curled portion and the cover member.

The motor may further include a bearing to which at least a portion of the rotor is coupled, wherein the housing may include a bearing seating portion so that the bearing is disposed around the opening.

The edge portion of the cover member may be sandwiched between the bearing and the curled portion.

The bearing may include an outer ring in fixed contact with the housing and an inner ring disposed inside the outer ring and in fixed contact with the rotor, and a protruding portion of the cover member may be provided at a center of the rotation axis and spaced a predetermined distance from the inner ring.

The housing may include a sidewall portion surrounding a radial outer side of the stator and an inclined portion configured to connect the sidewall portion and the bearing seating portion and form a predetermined angle with a radial direction.

The inclined portion may form an angle ranging from 20° to 60° with the radial direction.

The bearing seating portion may be provided to extend from the inclined portion, be bent two or more times, and comes into contact with an outer ring of the bearing.

The bearing seating portion may include a first sidewall formed by being bent from the inclined portion inward from the housing to be parallel to the rotation axis, a first support wall formed by being bent from the first sidewall toward the rotation axis, a second support wall formed by being bent 180° from the first support wall outward from the housing, and a second sidewall formed by being bent from the second support wall outward from the housing to be parallel to the rotation axis.

The curled portion may be formed by being curled from an end portion of the second sidewall.

A length of the second sidewall before the curled portion is formed by curling may be 1.2 times or more and 1.4 times or less a thickness of the outer ring of the bearing.

The first support wall may be spaced a predetermined distance from the rotor, and the second support wall may be in contact with the outer ring of the bearing and spaced a predetermined distance from the inner ring.

An inner diameter of the curled portion curvedly formed to face the rotation axis may be 0.9 times or less a diameter of an outer circumferential surface of the bearing.

An average radius of curvature of the curled portion from the wall forming the edge portion of the opening to a portion in contact with the edge portion of the cover member may be R2 or more and R4 or less.

In accordance with another aspect of the present disclosure, a method of manufacturing a motor including a stator and a rotor disposed to be spaced apart from an inner circumferential surface of the stator includes preparing a housing in which the stator and the rotor are accommodated and an opening centered on a rotation axis and exposing at least a portion of the rotor is provided, arranging a bearing in a bearing seating portion provided around the opening of the housing, arranging a cover member configured to cover the opening over the opening, and sealing the opening by curvedly curling a wall forming an edge portion of the opening toward the rotation axis to form a curled portion so that the curled portion comes into contact with an edge portion of the cover member.

The method may further include forming a sealant portion sealing a gap between the curled portion and the cover member by performing coating with a sealant between the curled portion and the cover member.

The sealing of the opening may include sandwiching the edge portion of the cover member between the bearing and the curled portion.

The preparing of the housing may include forming a sidewall portion surrounding a radial outer side of the stator and forming an inclined portion configured to connect the sidewall portion and the bearing seating portion and form a predetermined angle with a radial direction.

The preparing of the housing may further include forming the bearing seating portion, and the forming of the bearing seating portion may include forming a first sidewall by being bent from the inclined portion inward from the housing to be parallel to the rotation axis, forming a first support wall by being bent from the first sidewall toward the rotation axis, forming a second support wall by being bent 180° from the first support wall outward from the housing, and forming a second sidewall by being bent from the second support wall outward from the housing to be parallel to the rotation axis.

The forming of the curled portion may include curling an end portion of the second sidewall.

### BRIEF DESCRIPTION OF THE DRAWINGS

These and/or other aspects of the disclosure will become apparent and more readily appreciated from the following description of the embodiments, taken in conjunction with the accompanying drawings of which:

FIG. 1 is a schematic exploded perspective view illustrating a motor according to the present embodiment;

FIG. 2 is a schematic cross-sectional view illustrating an internal structure of the motor according to the present embodiment;

FIGS. 3 to 7 are schematic cross-sectional views illustrating a process of manufacturing the motor according to the present embodiment;

FIG. 8 is a schematic flowchart illustrating a method of manufacturing a motor according to the present embodiment;

FIG. 9 is a schematic flowchart illustrating a process of preparing a housing of the method of manufacturing a motor according to the present embodiment; and

FIG. 10 is a schematic flowchart illustrating a process of forming a bearing seating portion of the method of manufacturing a motor according to the present embodiment.

### DETAILED DESCRIPTION

Hereinafter, embodiments of the present disclosure will be described in detail with reference to the accompanying drawings. The following embodiments are provided to sufficiently convey the spirit of the present disclosure to those skilled in the art. The present disclosure is not limited to the embodiments disclosed herein and may be implemented in different forms. In the drawings, portions which are not related to the description may be omitted to clarify the present disclosure, and the sizes of components may be exaggerated to facilitate understanding of the present disclosure.

Hereinafter, the operating principle and embodiments of the present disclosure will be described with reference to the accompanying drawings.

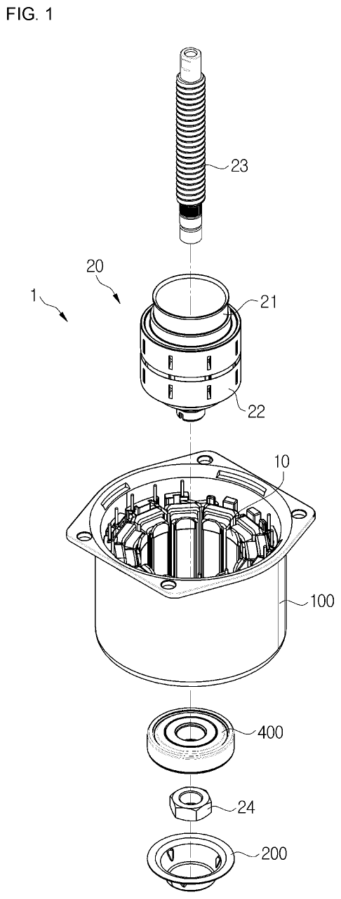

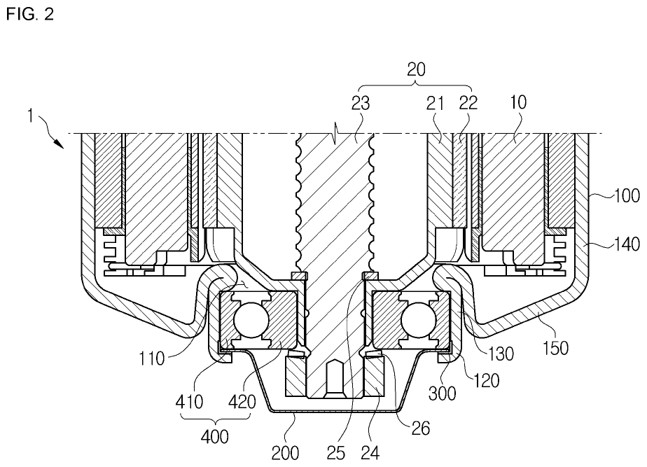

FIG. 1 is a schematic exploded perspective view illustrating a motor according to the present embodiment, and FIG. 2 is a schematic cross-sectional view illustrating an internal structure of the motor according to the present embodiment.

A motor 1 according to the present embodiment may transmit a driving force to a hydraulic pressure supply device of an electronic brake system. The hydraulic pressure supply device operates by receiving an electrical signal as the braking intention of a driver from a pedal displacement sensor which detects the displacement of a brake pedal and provides oil pressure transferred to a wheel cylinder of the electronic brake system. The hydraulic pressure supply device may be provided with various components. As an example, a piston moved by the driving force of the motor 1 may push oil in a chamber to transfer hydraulic pressure to the wheel cylinder.

In this case, the piston is connected to the motor 1 using a ball screw method so that the oil in the chamber may be pushed out according to the driving of the motor 1.

Referring to FIGS. 1 and 2, the configuration of the motor 1 according to the present embodiment having the ball screw method can be seen.

The motor 1 may include a stator 10 and a rotor 20 disposed to be spaced apart from an inner circumferential surface of the stator 10. The motor 1 may be coupled to a modulator block (not shown) in which a flow path and a valve for adjusting braking hydraulic pressure are provided.

When power is supplied, the motor 1 generates a rotational force. The motor 1 includes the stator 10 which receives power to generate an electric field and the rotor 20 which rotates by changes in the electric field, and the rotor 20 is disposed inside and spaced apart from the stator 10. Magnets 22 for generating a rotational force may be provided on the rotor 20, the plurality of magnets 22 are installed on an outer surface of the rotor 20, and a gap may be formed between the magnets 22 and the stator 10 so that the rotor 20 rotates without interference.

In the present embodiment, the motor 1 may be a hollow type motor. The rotor 20 of the hollow type motor may include a hollow shaft 21 having a tubular shape. The plurality of magnets 22 may be installed on an outer circumferential surface of the hollow shaft 21.

A screw shaft 23 of a ball screw may be disposed in the hollow portion of the hollow shaft 21. The screw shaft 23 may be coupled to the hollow shaft 21 and may rotate along with the hollow shaft 21. One end portion of the screw shaft 23 may be coupled to one end portion of the hollow shaft 21 to rotate along therewith, and a ball nut (not shown) may be disposed between and coupled to the screw shaft 23 and the hollow shaft 21 in a radial direction of rotation and move forward and backward according to rotation of the screw shaft 23.

The motor 1 according to the present embodiment including the stator 10 and the rotor 20 as described above may include a housing 100 in which the stator 10 and the rotor 20 are accommodated and an opening 110 centered on a rotation axis, which exposes at least a portion of the rotor 20 to the outside, is provided, a bearing 400 coupled to at least a portion of the rotor 20, and a cover member 200 which covers the opening 110 of the housing 100.

The housing 100 is provided to accommodate the stator 10 and the rotor 20 therein and surround the motor 1. In the present embodiment, one side of the housing 100 may be coupled to the modulator block.

The bearing 400 may be provided between the housing 100 and the rotor 20. The bearing 400 may be interposed between the housing 100 and the rotor 20 and rotatably support the rotor 20.

The housing 100 may include a bearing seating portion 130 so that the bearing 400 is disposed around the opening 110.

Referring to FIG. 2, the bearing seating portion 130 is provided in the housing 100 so that the bearing 400 disposed around the opening 110. The bearing 400 is disposed in the bearing seating portion 130 and coupled to the housing 100 and at least a portion of the rotor 20 to rotatably support the rotor 20 in the housing 100.

The bearing 400 may include an outer ring 410 which is in fixed contact with the housing 100 and an inner ring 420 which is disposed inside the outer ring 410 and is in fixed contact with the rotor 20. A structure such as a ball or roller for reducing friction may be provided between the outer ring 410 and the inner ring 420 so that the inner ring 420 easily rotates with respect to the outer ring 410.

At least a portion of the rotor 20 is coupled to the inner ring 420 of the bearing 400 through the opening 110 of the housing 100. In the present embodiment, one end portion of the hollow shaft 21 of the rotor 20 and one end portion of the screw shaft 23 may be coupled to the inner ring 420 of the bearing 400.

In the present embodiment, one end portion of the hollow shaft 21 may be press-fitted into the inner ring 420 of the bearing 400, and one end portion of the screw shaft 23 may be inserted into a hollow portion provided in one end portion of the hollow shaft 21.

A washer 25 may be disposed between the screw shaft 23 and the hollow shaft 21.

One end portion of the screw shaft 23 may be coupled to a fixing member 24 through the hollow portion of the hollow shaft 21 and the inner ring 420 of the bearing 400. As an example, the fixing member 24 may be provided as a nut, and a thread may be provided on one end portion of the screw shaft 23 to be screw-coupled to the fixing member 24.

A washer 26 may be disposed between the fixing member 24 and the inner ring 420 of the bearing 400. In the present embodiment, the washer 26 may be provided as a spring washer to allow the fixing member 24 to be coupled firmly.

The housing 100 may include a sidewall portion 140 surrounding a radial outer side of the stator 10 and an inclined portion 150 connecting the sidewall portion 140 and the bearing seating portion 130. The sidewall portion 140 and the inclined portion 150 will be described below.

In the case of the housing 100, the bearing 400, and the rotor 20, when the motor 1 is manufactured, the screw shaft 23, the bearing 400, the fixing member 24, and the like are assembled through the opening 110 of the housing 100. After the assembly is performed through the opening 110 in this way, the opening 110 needs to be sealed so that foreign matter is not introduced into the motor 1.

In the present embodiment, the cover member 200 may cover the opening 110 to seal the housing 100.

In the present embodiment, in the housing 100, a curled portion 120 curvedly curled may be formed such that a wall thereof forming an edge portion of the opening 110 faces the rotation axis of the motor, and the curled portion 120 may be in contact with an edge portion 220 of the cover member 200 to seal the opening 110.

As illustrated in FIG. 2, in the present embodiment, the curled portion 120 may be formed by curvedly curling the wall of the bearing seating portion 130 in which the bearing 400 is seated. In this way, as the wall of the bearing seating portion 130 is curvedly curled, the edge portion 220 of the cover member 200 may be sandwiched between the bearing 400 and the curled portion 120.

The wall of the bearing seating portion 130 may protrude more outward from the housing 100 than the bearing 400 disposed in the bearing seating portion 130. The wall protruding outward from the housing 100 may be curled toward the rotation axis of the motor 1 along an outer surface of the bearing 400 by a curling zig 5, which will be described below, and the like. As the cover member 200 is sandwiched between the curled portion 120 formed by the wall being curled in this way and the bearing 400, the cover member 200 may be fixed to the housing 100.

In the present embodiment, the motor 1 may further include a sealant portion 300 which seals a gap between the curled portion 120 and the cover member 200.

The sealant portion 300 may seal the gap between the curled portion 120 and the cover member 200, a gap between the cover member 200 and the bearing 400, or a gap between the bearing 400 and the bearing seating portion 130.

The sealant portion 300 may be formed by performing coating with a sealant in a circumferential direction of the bearing 400 disposed in the bearing seating portion 130 or performing coating with the sealant in a circumferential direction of the cover member 200.

As described above, the sealant portion 300 formed by performing coating with the sealant as described above may be in contact with the bearing 400 and the cover member 200 or with the curled portion 120 and the cover member 200 to seal the gap therebetween.

As illustrated in FIG. 2, the curled portion 120 is curvedly formed to face the rotation axis of the motor 1 and is in contact with the edge portion 220 of the cover member 200. In this case, the curled portion 120 should be in contact with a predetermined area or more of the cover member 200 to firmly fix the cover member 200 and the bearing 400.

To this end, an inner diameter of the curled portion 120 curvedly formed to face the rotation axis of the motor 1 may be 0.9 times or less a diameter of an outer circumferential surface of the bearing 400. That is, the curled portion 120 may support the bearing 400 through the cover member 200 in a region greater than or equal to 0.1 times the diameter of the outer circumferential surface of the bearing 400.

In this way, as an area supporting the curled portion 120, the cover member 200, and the bearing 400 increases, the bearing 400 and the rotor 20 coupled to the bearing 400 may be firmly supported, and a gap between the bearing 400, the cover member, and the curled portion 120 may be sealed.

Hereinafter, a process of manufacturing the motor 1 according to the present embodiment will be described.

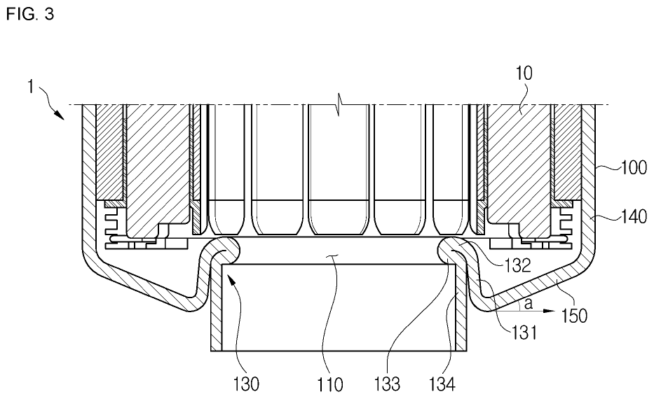

FIGS. 3 to 7 are schematic cross-sectional views illustrating a process of manufacturing the motor according to the present embodiment.

Referring to FIG. 3, a state in which the housing 100 is coupled to the stator 10 can be seen.

The housing 100 according to the present embodiment may include the bearing seating portion 130 so that the bearing 400 is disposed around the opening 110, the sidewall portion 140 surrounding the radial outer side of the stator 10, and the inclined portion 150 which connects the sidewall portion 140 and the bearing seating portion 130 and forms a predetermined angle a with the radial direction.

The sidewall portion 140 surrounds the radial outer side of the stator 10 to form a space in which the stator 10 and the rotor 20 are accommodated. The stator 10 may be fixedly disposed on an inner circumferential surface of the sidewall portion 140.

The bearing seating portion 130 in which the bearing 400 is disposed is provided in the opening 110 centered on the rotation axis. In this case, the bearing seating portion 130 and the sidewall portion 140 are connected by the inclined portion 150.

The inclined portion 150 connects the bearing seating portion 130 and the sidewall portion 140 and surrounds a surface of the motor 1 in a rotation axis direction. In this case, as illustrated in FIG. 3, the inclined portion 150 forms the predetermined angle a with the radial direction (left-right direction of FIG. 3).

As the motor 1 according to the present embodiment includes a ball screw structure, a ball nut (not shown) of the ball screw is moved forward and backward by rotation of the motor 1. Accordingly, a load in the rotation axis direction is applied to the screw shaft 23 of the ball screw.

When the load in the rotation axis direction is applied to the screw shaft 23, the load is transferred to the bearing 400 connected to the screw shaft 23, and when the load is applied to the bearing 400, the load is transferred to the bearing seating portion 130 of the housing 100 to which the bearing 400 is coupled.

When the inclined portion 150 is formed to extend in the radial direction without forming an angle with the radial direction, and the load in the rotation axis direction is transferred to the bearing seating portion 130, the inclined portion 150 may be deformed by the load in the rotation axis direction. Accordingly, the inclined portion 150 may be deformed according to driving of the motor 1 such that a force due to forward and backward movement of the ball nut may not be smoothly transmitted, or vibrations may occur due to the deformation of the inclined portion 150 to generate noise.

In this case, when the angle a formed by the inclined portion 150 with the radial direction is too small, the inclined portion 150 may be deformed depending on the load, and when the angle a is too large, the housing 100 may be excessively large compared to a structure in the motor 1.

Preferably, the inclined portion 150 according to the present embodiment may form an angle ranging from 20° to 60° with the radial direction.

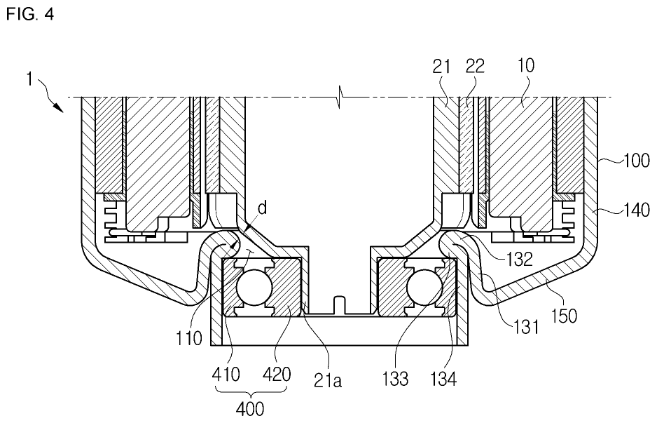

Referring to FIG. 4, the bearing 400 may be disposed in the bearing seating portion 130 of the housing 100 to which the stator 10 is coupled, and the hollow shaft 21 may be coupled to the bearing 400.

The bearing seating portion 130 may be formed as a part of the housing 100 and may extend from the inclined portion 150. Since the bearing seating portion 130 extends from the inclined portion 150 and has a shape corresponding to an outer shape of the bearing 400, the bearing 400 may be coupled to the bearing seating portion 130.

The bearing seating portion 130 according to the present embodiment may extend from the inclined portion 150 and may be bent two or more times to come into contact with the outer ring 410 of the bearing 400.

Specifically, the bearing seating portion 130 may include a first sidewall 131 formed by being bent inward from the housing 100 from the inclined portion 150 to be parallel to the rotation axis of the motor 1, a first support wall 132 formed by being bent from the first sidewall 131 toward the rotation axis, a second support wall 133 formed by being bent 180° outward from the housing from the first support wall 132, and a second sidewall 134 formed by being bent from the second support wall outward from the housing to be parallel to the rotation axis of the motor 1.

As described above, the bearing seating portion 130 may extend from the inclined portion 150 and may be bent to come into contact with and support the outer ring 410 of the bearing 400.

In the present embodiment, the second support wall 133 is in contact with the outer ring 410 of the bearing 400 in the rotation axis direction (vertical direction of FIG. 4) of the motor 1 to support the bearing 400, and the second sidewall 134 is in contact with the outer ring 410 of the bearing 400 in the radial direction (left-right direction of FIG. 4) of the motor 1 to support the bearing 400.

The first support wall 132 may be in contact with and support the second support wall 133, and the first sidewall 131 may be in contact with and support the second sidewall 134. As described above, in the bearing seating portion 130 according to the present embodiment, the support wall and the sidewall may be formed as a double structure to firmly support the bearing 400.

As illustrated in FIG. 4, the first support wall 132 according to the present embodiment may protrude inward from the housing 100 to support the bearing 400. In this case, when the first support wall 132 is in contact with the rotor 20 inside the housing 100, the rotor 20 cannot rotate freely, and thus driving of the motor 1 is disrupted.

In order to prevent the driving of the motor 1 from being disrupted as described above, the first support wall 132 according to the present embodiment is spaced a predetermined distance d from the rotor 20.

In addition, since the rotor 20 is coupled to and rotated along with the inner ring 420 of the bearing 400, when the bearing seating portion 130 which supports the bearing 400 is in contact with the inner ring 420, the rotor 20 cannot rotate freely, and thus driving of the motor 1 is disrupted.

In order to prevent the driving of the motor 1 from being disrupted as described above, the second support wall 133 according to the present embodiment may be in contact with the outer ring 410 of the bearing 400 and may be spaced a predetermined distance from the inner ring 420.

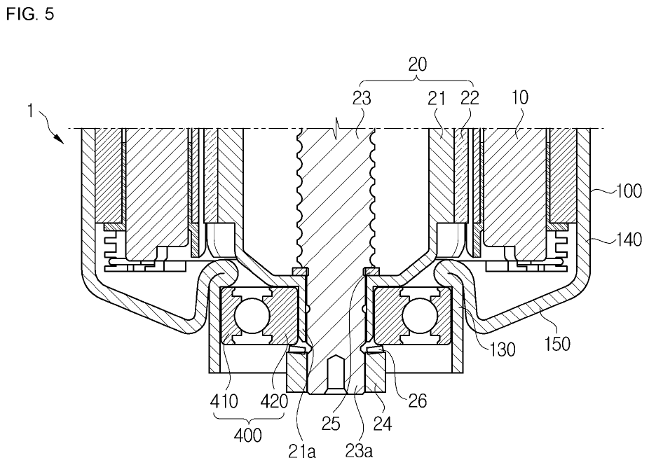

Referring to FIG. 5, the screw shaft 23 may be coupled to the bearing seating portion 130 through the hollow portion of the hollow shaft 21 coupled to the bearing 400.

As one end portion of the screw shaft 23 is inserted into the hollow portion provided in one end portion of the hollow shaft 21, the screw shaft 23 is coupled to the inner ring 420 of the bearing 400. The washer 25 may be disposed between the screw shaft 23 and the hollow shaft 21.

Meanwhile, one end portion of the screw shaft 23 may pass through the hollow portion of the hollow shaft 21 and the inner ring 420 of the bearing 400 and may be coupled to the fixing member 24. As one end portion of the screw shaft 23 is coupled to the fixing member 24 in this way, the screw shaft 23 and the hollow shaft 21 may be firmly coupled to and rotated along with the inner ring 420 of the bearing 400. The washer 26 may be disposed between the fixing member 24 and the inner ring 420 of the bearing 400.

As one end portion of the screw shaft 23 and the fixing member 24 are exposed to the outside of the housing 100 through the opening 110 of the housing 100, when the motor 1 is assembled, a worker can assemble the components from the outside of the housing 100.

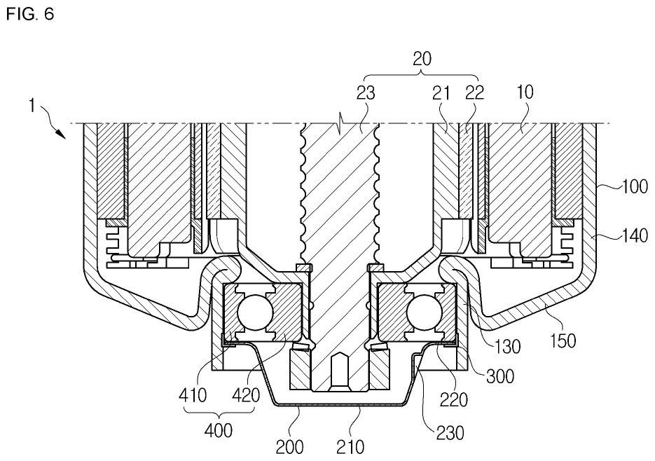

Referring to FIG. 6, the cover member 200 may be disposed to cover the bearing 400 and an outer side of the screw shaft 23 coupled to the bearing 400 which are assembled in the opening 110 of the housing 100.

The cover member 200 is provided to cover the opening 110 of the housing 100 to seal the housing 100. The cover member 200 according to the present embodiment may be provided to have a diameter almost equal to a diameter of the bearing 400, inserted into the second sidewall 134 of the bearing seating portion 130, and may be in contact with the outer ring 410 of the bearing 400.

Meanwhile, in the cover member 200, a protruding portion 210 may be provided at a center of the rotation axis of the motor 1. The protruding portion 210 may be provided to protrude from the cover member 200 at the center of the rotation axis of the motor 1 outward from the housing 100. An end portion of the screw shaft 23 and the fixing member 24 may be accommodated inside the protruding portion 210.

The edge portion 220 of the cover member 200 is fixedly sandwiched between the curled portion 120 of the housing 100 and the outer ring 410 of the bearing 400. As described above, when the cover member 200 fixed in this way is in contact with the rotor 20 or the inner ring 420 of the bearing 400 coupled to the rotor 20, the rotor 20 cannot rotate freely, and thus driving of the motor 1 is disrupted.

In order to prevent the driving of the motor 1 from being disrupted as described above, the protruding portion 210 according to the present embodiment may be spaced a predetermined distance from the inner ring 420 of the bearing 400. The protruding portion 210 may not only be spaced the predetermined distance from the inner ring 420 of the bearing 400 but may also be spaced a predetermined distance from the rotor 20, that is, one end portion of the screw shaft 23 and the fixing member 24 coupled to one end portion of the screw shaft 23.

A plurality of concave portions 230 may be provided in the protruding portion 210 of the cover member 200. The concave portions 230 may be provided so that at least some portions of the protruding portion 210 are recessed inward of the housing 100. The plurality of concave portions 230 may be provided to fix the cover member 200 or to set a position and a direction of the cover member 200 when the cover member 200 is assembled.

The sealant portion 300 may be formed on the edge portion 220 of the cover member 200. The sealant portion 300 is provided to seal the housing 100.

In the present embodiment, the edge portion 220 of the cover member 200 or an outer side of the outer ring 410 of the bearing 400 may be coated with the sealant in a circumferential direction to form the sealant portion 300. In other words, after the outer side of the outer ring 410 may be coated with the sealant in the circumferential direction, the cover member 200 may be disposed outside the bearing 400, after at least one side of an inner side and an outer side of the edge portion 220 of the cover member 200 is coated with the sealant in the circumferential direction, the cover member 200 may be disposed outside the bearing 400, or after the cover member 200 is disposed outside the bearing 400, the outer side of the edge portion 220 of the cover member 200 may be coated with the sealant in the circumferential direction.

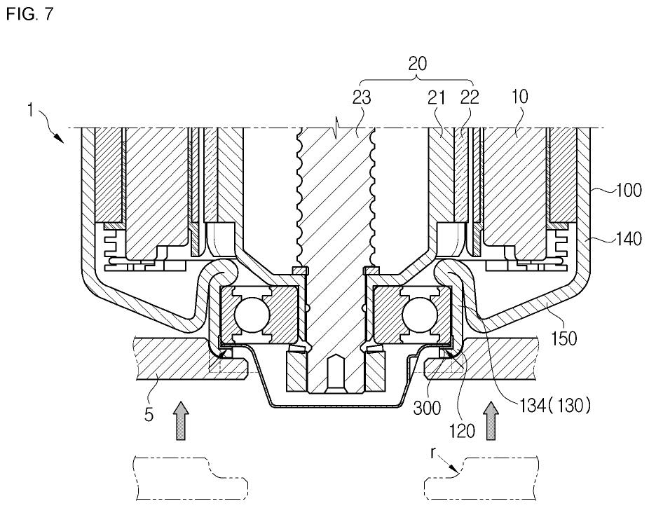

Referring to FIG. 7, as the curled portion 120 is formed, the cover member 200 disposed outside the bearing 400 may be sandwiched by the bearing 400 and the curled portion 120.

As described above, the curled portion 120 is formed to be curvedly curled such that the wall thereof forming the edge portion of the opening faces the rotation axis. More specifically, the curled portion 120 is formed by being curled from an end portion of the second sidewall 134 of the bearing seating portion 130.

The curling zig 5 may be used to form the curled portion 120. The curling zig 5 includes a curved portion for forming the curled portion 120, which comes into contact with the second sidewall 134 and presses the second sidewall 134 to curl the second sidewall 134.

Preferably, the curling zig 5 may come into contact with the second sidewall 134 while rotating to curl the second sidewall 134 provided in a cylindrical shape to be curved toward the rotation axis of the motor 1.

The curling zig 5 may curl the second sidewall 134 using a predetermined load to form the curled portion 120. After the bearing 400 and the cover member 200 are disposed in the bearing seating portion 130, as the second sidewall 134 is curled, the end portion of the second sidewall 134 curvedly curled to face the rotation axis comes into contact with the cover member 200 and an outer side of the bearing 400 to fix the bearing 400 and the cover member 200. In this case, as the curling zig 5 adjusts the load for curling the second sidewall 134, the curled portion 120 may sufficiently firmly support the bearing 400. In the embodiment of the present disclosure, the curling zig 5 may curl the second sidewall 134 using a load of 1350 kgf to 1550 kgf.

Meanwhile, the end portion of the second sidewall 134 may be curled to form the curled portion 120 which may support the cover member 200 and the bearing 400 by coming into contact with the edge portion 220 of the cover member 200. In this case, an area in contact with the edge portion 220 of the cover member 200 may be determined according to a length of the second sidewall 134 protruding outward from the bearing 400 when the bearing 400 is disposed in the bearing seating portion 130.

Accordingly, in the embodiment of the present disclosure, the length before the curled portion 120 of the second sidewall 134 is curled may be 1.2 times or more and 1.4 times or less a thickness of the outer ring 410 of the bearing 400 to secure an area of the curled portion 120 in contact with the edge portion 220 of the cover member 200. That is, when the bearing 400 is disposed in the bearing seating portion 130, a portion of the second sidewall 134 is in contact with the outer ring 410 of the bearing 400, and the remaining portion, that is, a length corresponding to 0.2 to 0.4 times the thickness of the outer ring 410 of the bearing 400 protrudes. As the protruding end portion of the second sidewall 134 is curled in this way, a sufficiently large area of the second sidewall 134 may be brought into contact with the cover member 200.

In the embodiment of the present disclosure, an average radius of curvature of the curled portion 120 from the wall forming the edge portion of the opening 110 to a portion in contact with the edge portion 220 of the cover member 200 may be R2 or more and R4 or less.

When the average radius of curvature of the curled portion 120 is too small, since the curled portion 120 is sharply curved, a sufficient force may not be applied to support the bearing 400 and the cover member 200, and when the average radius of curvature of the curled portion 120 is too large, a space is generated between a portion of an edge portion of the bearing 400 and the curled portion 120, and thus vibrations may occur when the motor 1 is driven. Accordingly, the average radius of curvature of the curled portion 120 according to the present embodiment may be R2 or more and R4 or less to firmly support the bearing 400 and the cover member 200 and also reduce vibrations and noise when the motor 1 is driven.

In the embodiment of the present disclosure, for the curled portion 120 to have such an average radius of curvature, a contact surface of the curling zig 5 may have a radius of curvature corresponding to the average radius of curvature of the curled portion 120.

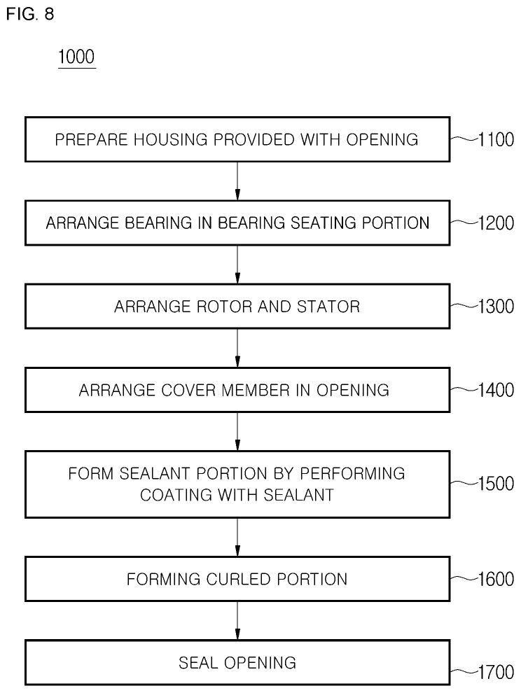

FIG. 8 is a schematic flowchart illustrating a method of manufacturing a motor according to the present embodiment.

Referring to FIG. 8, a method of manufacturing the motor 1 according to the present embodiment can be seen.

Referring to FIG. 8, in a method 1000 of manufacturing the motor 1 according to the present embodiment, first, the housing 100, in which the stator 10 and the rotor 20 are accommodated and the opening 110, which exposes at least a portion of the rotor 20 to the outside around the rotation axis, is provided, is prepared (1100).

As illustrated in FIG. 3, the housing 100 may include the bearing seating portion 130 so that the bearing 400 is disposed around the opening 110, the sidewall portion 140 surrounding the radial outer side of the stator 10, and the inclined portion 150 which connects the sidewall portion 140 and the bearing seating portion 130 and forms the predetermined angle a with the radial direction. A method of preparing the housing 100 will be described below.

Then, the bearing 400 is disposed in the bearing seating portion 130 provided around the opening 110 of the housing 100 (1200).

As described above, the bearing 400 may be disposed in the bearing seating portion 130 provided in the housing 100. The bearing seating portion 130 is provided around the opening 110 of the housing 100 to support the bearing 400. As the bearing 400 is disposed and supported in the bearing seating portion 130, the bearing 400 may be fixed to the housing 100.

Then, the stator 10 and the rotor 20 are disposed in the housing 100 (1300). Since at least a portion of the rotor 20 should be exposed to the outside through the opening 110 and coupled to the bearing 400, the rotor 20 is preferably coupled to the bearing 400 after the bearing 400 is disposed in the bearing seating portion 130. However, since the stator 10 is fixed to the inner side of the housing 100, the stator 10 may be disposed in the housing 100 before the bearing 400 is disposed therein.

In the present embodiment, as illustrated in FIG. 5, the rotor 20 may be firmly coupled to the inner ring 420 of the bearing 400 through the fixing member 24.

Then, the cover member 200 which covers the opening 110 is disposed over the opening 110 (1400).

The cover member 200 may cover the opening 110, and the edge portion of the cover member 200 may be in contact with the outer ring 410 of the bearing 400.

Then, coating with the sealant is performed between the curled portion 120 and the cover member 200 to form the sealant portion 300 which seals the gap between the curled portion 120 and the cover member 200 (1500). Here, although it is disclosed that coating with the sealant is performed to form the sealant portion 300 after the cover member 200 is disposed over the opening 110, the present disclosure is not limited thereto. Coating may first be performed on the outer ring 410 of the bearing 400 with the sealant in the circumferential direction, and then the cover member 200 may be disposed on the coated sealant.

The coated sealant may seal the opening 110 of the housing 100 by sealing a gap between the outer ring 410 of the bearing 400, the cover member 200, and the curled portion 120 which will be described below.

Then, the curled portion 120 is formed by curvedly curling the wall forming the edge portion of the opening 110 toward the rotation axis of the motor 1 (1600).

As illustrated in FIG. 7, the curled portion 120 may be formed by curling the wall forming the edge portion of the opening 110 of the housing 100, for example, the end portion of the second sidewall 134 of the bearing seating portion 130, using the curling zig 5.

In this case, the opening 110 may be sealed by allowing the curled portion 120 to come into contact with the edge portion 220 of the cover member 200 (1700).

In this case, the sealing of the opening 110 (1700) may include sandwiching the edge portion 220 of the cover member 200 between the bearing 400 and the curled portion 120.

As described above with reference to FIG. 2, as the curled portion 120 is formed to be curvedly curled to face the rotation axis and the curled portion 120 comes into contact with the edge portion 220 of the cover member 200, the edge portion 220 of the cover member 200 is fixedly sandwiched between the bearing 400 and the curled portion 120.

In this case, as the sealant portion 300 is formed on the edge portion 220 of the cover member 200 by the coated sealant, the gap between the cover member 200 and the curled portion 120 or the gap between the cover member 200 and the bearing 400 is sealed.

In the method 1000 of manufacturing the motor 1 according to the present embodiment, the fixing and the sealing of the bearing 400 can be simply performed through the curling process without the need for a separate member for sealing the opening 110 of the housing 100 as described above.

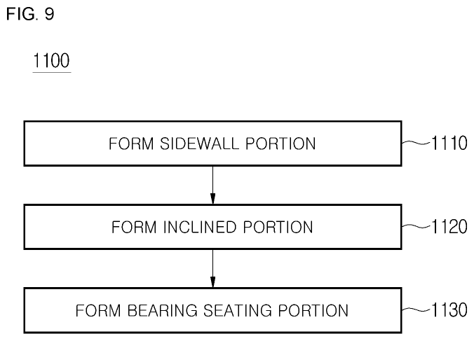

FIG. 9 is a schematic flowchart illustrating the process of preparing the housing of the method of manufacturing a motor according to the present embodiment. Referring to FIG. 9, detailed operations of the preparation of the housing 100 (1100) described with reference to FIG. 8 can be seen.

In the preparation of the housing 100 (1100) according to the present embodiment, first, the sidewall portion 140 surrounding the radial outer side of the stator 10 may be formed (1110).

The sidewall portion 140 may be provided in a cylindrical shape surrounding the radial outer side of the stator 10.

Then, the inclined portion 150 which connects the sidewall portion 140 and the bearing seating portion 130 and forms the predetermined angle with the radial direction may be formed (1120).

The inclined portion 150 may be connected to the sidewall portion 140 while forming the predetermined angle with the radial direction and may surround one side of the housing 100 in the rotation axis direction. Since the inclined portion 150 forms the predetermined angle with the radial direction, the inclined portion 150 may have an overall conical shape.

The inclined portion 150 may be formed by being bent from the sidewall portion 140.

Then, the bearing seating portion 130 may be formed (1130).

The bearing seating portion 130 may come into contact with the outer ring 410 of the bearing 400 to couple the bearing 400 to the housing 100. The bearing seating portion 130 may be provided in a shape corresponding to the outer ring 410 to come into contact with the outer ring 410.

The bearing seating portion 130 according to the present embodiment may be formed by being bent from the inclined portion 150.

Meanwhile, in the FIG. 9, although it is illustrated that the sidewall portion 140, the inclined portion 150, and the bearing seating portion 130 are sequentially formed, the present disclosure is not limited thereto, and at least two among the sidewall portion 140, the inclined portion 150, and the bearing seating portion 130 may be formed at the same time, or the sidewall portion 140, the inclined portion 150, and the bearing seating portion 130 may be formed in a different order.

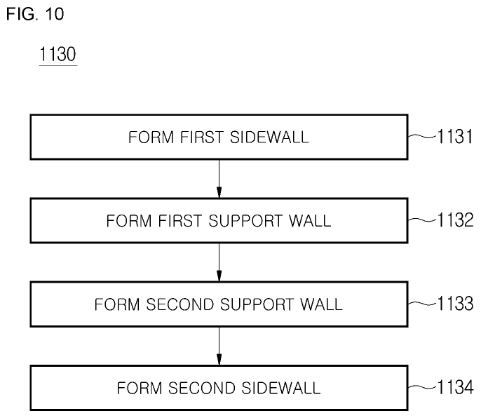

FIG. 10 is a schematic flowchart illustrating the process of forming the bearing seating portion of the method of manufacturing a motor according to the present embodiment.

Referring to FIG. 10, detailed operations of the formation of the bearing seating portion 130 (1130) described with reference to FIG. 9 can be seen.

The formation of the bearing seating portion 130 (1130) according to the present embodiment may include forming the first sidewall 131 by being bent inward from the housing 100 from the inclined portion 150 to be parallel to the rotation axis (1131), forming the first support wall 132 by being bent from the first sidewall 131 toward the rotation axis (1132), forming the second support wall 133 by being bent 180° outward from the housing 100 from the first support wall 132 (1133), and forming the second sidewall 134 by being bent outward from the housing 100 from the second support wall 133 to be parallel to the rotation axis (1134).

Meanwhile, in FIG. 10, although it is illustrated that the first sidewall 131, the first support wall 132, the second support wall 133, and the second sidewall 134 are sequentially formed, the present disclosure is not limited thereto. At least two among the first sidewall 131, the first support wall 132, the second support wall 133, and the second sidewall 134 may be formed at the same time, or the first sidewall 131, the first support wall 132, the second support wall 133, and the second sidewall 134 may be formed in a different order.

According to a motor and a method of manufacturing the same according to the present embodiment, the number of components and the number of processes required to seal a housing of the motor can be reduced.

According to a motor and a method of manufacturing the same according to the present embodiment, a housing of the motor can easily support a bearing coupled to a rotor to which a load is applied.

According to a motor and a method of manufacturing the same according to the present embodiment, noise which can occur in a sealing structure can be reduced.

What is claimed is:

1. A motor including a stator and a rotor disposed to be spaced apart from an inner circumferential surface of the stator, the motor comprising:
a housing in which the stator and the rotor are accommodated and an opening centered on a rotation axis and exposing at least a portion of the rotor is provided; and
a cover member covering the opening of the housing,
wherein, in the housing, a curled portion is formed to be curvedly curled such that a wall thereof forming an edge portion of the opening faces the rotation axis, and the curled portion comes into contact with an edge portion of the cover member to seal the opening.

2. The motor of claim 1, further comprising a sealant portion sealing a gap between the curled portion and the cover member.

3. The motor of claim 1, further comprising a bearing to which at least a portion of the rotor is coupled,
wherein the housing includes a bearing seating portion so that the bearing is disposed around the opening.

4. The motor of claim 3, wherein the edge portion of the cover member is sandwiched between the bearing and the curled portion.

5. The motor of claim 4, wherein:
the bearing includes an outer ring in fixed contact with the housing and an inner ring disposed inside the outer ring and in fixed contact with the rotor; and
a protruding portion of the cover member is provided at a center of the rotation axis and spaced a predetermined distance from the inner ring.

6. The motor of claim 3, wherein the housing includes:
a sidewall portion surrounding a radial outer side of the stator; and
an inclined portion configured to connect the sidewall portion and the bearing seating portion and form a predetermined angle with a radial direction.

7. The motor of claim 6, wherein the inclined portion forms an angle ranging from 20° to 60° with the radial direction.

8. The motor of claim 6, wherein the bearing seating portion is provided to extend from the inclined portion, is bent two or more times, and comes into contact with an outer ring of the bearing.

9. The motor of claim 8, wherein the bearing seating portion includes:
a first sidewall formed by being bent from the inclined portion inward from the housing to be parallel to the rotation axis;
a first support wall formed by being bent from the first sidewall toward the rotation axis;
a second support wall formed by being bent 180° from the first support wall outward from the housing; and
a second sidewall formed by being bent from the second support wall outward from the housing to be parallel to the rotation axis.

10. The motor of claim 9, wherein the curled portion is formed by being curled from an end portion of the second sidewall.

11. The motor of claim 10, wherein a length of the second sidewall before the curled portion is formed by curling is 1.2 times or more and 1.4 times or less a thickness of the outer ring of the bearing.

12. The motor of claim 9, wherein:
the first support wall is spaced a predetermined distance from the rotor; and
the second support wall is in contact with the outer ring of the bearing and spaced a predetermined distance from the inner ring.

13. The motor of claim 3, wherein an inner diameter of the curled portion curvedly formed to face the rotation axis is 0.9 times or less a diameter of an outer circumferential surface of the bearing.

14. The motor of claim 1, wherein an average radius of curvature of the curled portion from the wall forming the edge portion of the opening to a portion in contact with the edge portion of the cover member is R2 or more and R4 or less.

15. A method of manufacturing a motor including a stator and a rotor disposed to be spaced apart from an inner circumferential surface of the stator, the method comprising:
preparing a housing in which the stator and the rotor are accommodated and an opening centered on a rotation axis and exposing at least a portion of the rotor is provided;
arranging a bearing in a bearing seating portion provided around the opening of the housing;
arranging a cover member configured to cover the opening over the opening; and
sealing the opening by curvedly curling a wall forming an edge portion of the opening toward the rotation axis to form a curled portion so that the curled portion comes into contact with an edge portion of the cover member.

16. The method of claim 15, further comprising forming a sealant portion sealing a gap between the curled portion and the cover member by performing coating with a sealant between the curled portion and the cover member.

17. The method of claim 15, wherein the sealing of the opening includes sandwiching the edge portion of the cover member between the bearing and the curled portion.

18. The method of claim 15, wherein the preparing of the housing includes:
forming a sidewall portion surrounding a radial outer side of the stator; and
forming an inclined portion configured to connect the sidewall portion and the bearing seating portion and form a predetermined angle with a radial direction.

19. The method of claim 18, wherein:
the preparing of the housing further includes forming the bearing seating portion; and
the forming of the bearing seating portion includes forming a first sidewall by being bent from the inclined portion inward from the housing to be parallel to the rotation axis, forming a first support wall by being bent from the first sidewall toward the rotation axis, forming a second support wall by being bent 180° from the first support wall outward from the housing, and forming a second sidewall by being bent from the second support wall outward from the housing to be parallel to the rotation axis.

20. The method of claim 19, wherein the forming of the curled portion includes curling an end portion of the second sidewall.
